(19) United States
(12) Patent Application Publication
(10) Pub. No.: US 2024/0267990 A1
(43) Pub. Date: Aug. 8, 2024

(54) RADIO ACCESS NETWORK NODE REQUEST FOR CORE NETWORK PAGING

(71) Applicant: QUALCOMM Incorporated, San Diego, CA (US)

(72) Inventors: Naeem AKL, Bridgewater, NJ (US); Hong CHENG, Basking Ridge, NJ (US); Karl Georg HAMPEL, Jersey City, NJ (US)

(21) Appl. No.: 18/515,757

(22) Filed: Nov. 21, 2023

Related U.S. Application Data
(60) Provisional application No. 63/483,688, filed on Feb. 7, 2023.

(51) Int. Cl. H04W 76/30; H04W 68/02; H04W 72/20

(52) U.S. Cl. CPC H04W 76/30; H04W 68/02; H04W 72/20

(57) ABSTRACT

Various aspects of the present disclosure generally relate to wireless communication. In some aspects, a radio access network (RAN) node may release a radio resource control (RRC) connection of a user equipment (UE). The RAN node may transmit a request to a core network (CN) node to initiate paging for the UE, the request including an identifier of the UE. Numerous other aspects are described.

### CROSS-REFERENCE TO RELATED APPLICATION

This Patent Application claims priority to U.S. Provisional Patent Application No. 63/483,688, filed on Feb. 7, 2023, entitled “RADIO ACCESS NETWORK NODE REQUEST FOR CORE NETWORK PAGING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for a radio access network (RAN) node request for core network paging.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some networks, a user equipment (UE) may be radio resource control (RRC) released to an RRC state associated with a core network (CN) node. In the RRC state associated with the CN node, a radio access network (RAN) node may be unable to page the UE to reestablish an RRC connection. Based at least in part on the RAN node being unable to page the UE to reestablish the RRC connection, the RAN node may be unable to transmit control information or data to the UE while the UE is in the RRC state associated with the CN node (e.g., an RRC-idle state). In this case, the RAN node may be unable to provide control information that may have otherwise been used to conserve power, network, communication, or computing resources, and/or an additional UE having a link to the RAN node via the UE may experience radio link failure and/or poor spectral efficiency. Additionally, or alternatively, the data may become stale and unusable, which may degrade performance and/or a user experience at the UE or the additional UE.

In some aspects described herein, a RAN node may request a CN node to initiate paging for a UE in an idle state or other state where the RAN node does not have information or a capability to page the UE without the CN node. For example, the RAN node may request the CN node to initiate paging for a mobile terminal (MT) of a forwarding node (such as a network controlled repeater (NCR)-MT). The RAN node may use a UE identifier that is known by the RAN node and the CN node to indicate the UE for which paging is requested. In some aspects, the CN node may retain the UE identifier based at least in part on a UE type of the UE (e.g., an NCR-MT) to support the paging request from the RAN node. In this way, the RAN node may provide control information that may be used to conserve power, network, communication, or computing resources, and/or an additional UE having a link to the RAN node via the UE may avoid radio link failure and/or communicate with improved spectral efficiency. Additionally, or alternatively, the data may be provided to the UE within a latency requirement and/or before expiry of the date, which may improve performance and/or a user experience at the UE or the additional UE.

Some aspects described herein relate to a method of wireless communication performed by a RAN node. The method may include releasing an RRC connection of a UE. The method may include transmitting a request to a CN node to initiate paging for the UE, the request including an identifier of the UE.

Some aspects described herein relate to a method of wireless communication performed by a CN node. The method may include receiving a first request from a first RAN node to initiate paging for a UE, the first request including a first identifier of the UE. The method may include transmitting a second request to a second RAN node to page the UE based at least in part on receiving the first request, wherein the second request comprises a second identifier of the UE.

Some aspects described herein relate to a RAN node for wireless communication. The RAN node may include one or more memories and one or more processors coupled to the one or more memories. The one or more processors may be configured to release an RRC connection of a UE. The one or more processors may be configured to transmit a request to a CN node to initiate paging for the UE, the request including an identifier of the UE.

Some aspects described herein relate to a CN node for wireless communication. The CN node may include one or more memories and one or more processors coupled to the one or more memories. The one or more processors may be configured to receive a first request from a first RAN node to initiate paging for a UE, the first request including a first identifier of the UE. The one or more processors may be configured to transmit a second request to a second RAN node to page the UE based at least in part on receiving the first request, wherein the second request comprises a second identifier of the UE.

Some aspects described herein relate to a non-transitory computer-readable medium that stores a set of instructions for wireless communication by a RAN node. The set of instructions, when executed by one or more processors of the RAN node, may cause the RAN node to release an RRC connection of a UE. The set of instructions, when executed by one or more processors of the RAN node, may cause the RAN node to transmit a request to a CN node to initiate paging for the UE, the request including an identifier of the UE.

Some aspects described herein relate to a non-transitory computer-readable medium that stores a set of instructions for wireless communication by a CN node. The set of instructions, when executed by one or more processors of the CN node, may cause the CN node to receive a first request from a first RAN node to initiate paging for a UE, the first request including a first identifier of the UE. The set of instructions, when executed by one or more processors of the CN node, may cause the CN node to transmit a second request to a second RAN node to page the UE based at least in part on receiving the first request, wherein the second request comprises a second identifier of the UE.

Some aspects described herein relate to an apparatus for wireless communication. The apparatus may include means for releasing an RRC connection of a UE. The apparatus may include means for transmitting a request to a CN node to initiate paging for the UE, the request including an identifier of the UE.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of communicating using a millimeter wave repeater, in accordance with the present disclosure.

FIG. 5 is a diagram illustrating an example of communicating using a forwarding node (e.g., a relay and/or a repeater, such as a millimeter wave repeater), in accordance with the present disclosure.

FIG. 6 is a diagram illustrating an example of a radio resource control (RRC) release and paging process.

FIG. 7 is a diagram of an example associated with a radio access network (RAN) node request for core network (CN) paging, in accordance with the present disclosure.

FIG. 8 is a diagram illustrating an example process performed, for example, by a RAN node, in accordance with the present disclosure.

FIG. 9 is a diagram illustrating an example process performed, for example, by a CN node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

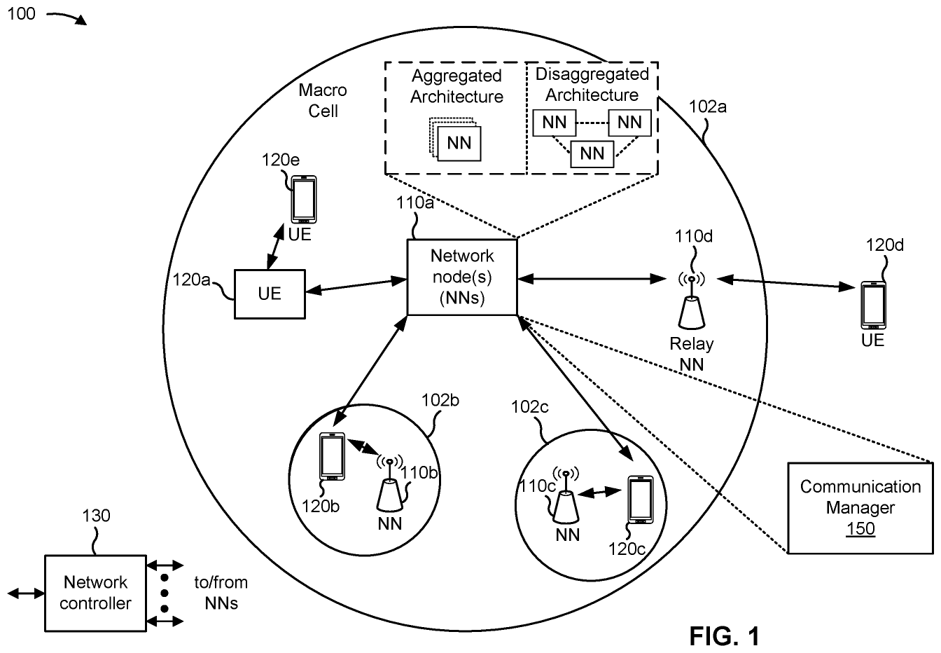

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a RAN node may include a communication manager 150. As described in more detail elsewhere herein, the communication manager 150 may release a radio resource control (RRC) connection of a UE; and transmit a request to a core network (CN) node to initiate paging for the UE, the request including an identifier of the UE. Additionally, or alternatively, the communication manager 150 may perform one or more other operations described herein.

In some aspects, a CN node may include a communication manager 150. As described in more detail elsewhere herein, the communication manager 150 may receive a first request from a first RAN node to initiate paging for a UE, the first request including a first identifier of the UE; and transmit a second request to a second RAN node to page the UE based at least in part on receiving the first request, wherein the second request comprises a second identifier of the UE. Additionally, or alternatively, the communication manager 150 may perform one or more other operations described herein.

As indicated above, FIG. 1 is provided as an example. Other examples may differ from what is described with regard to FIG. 1.

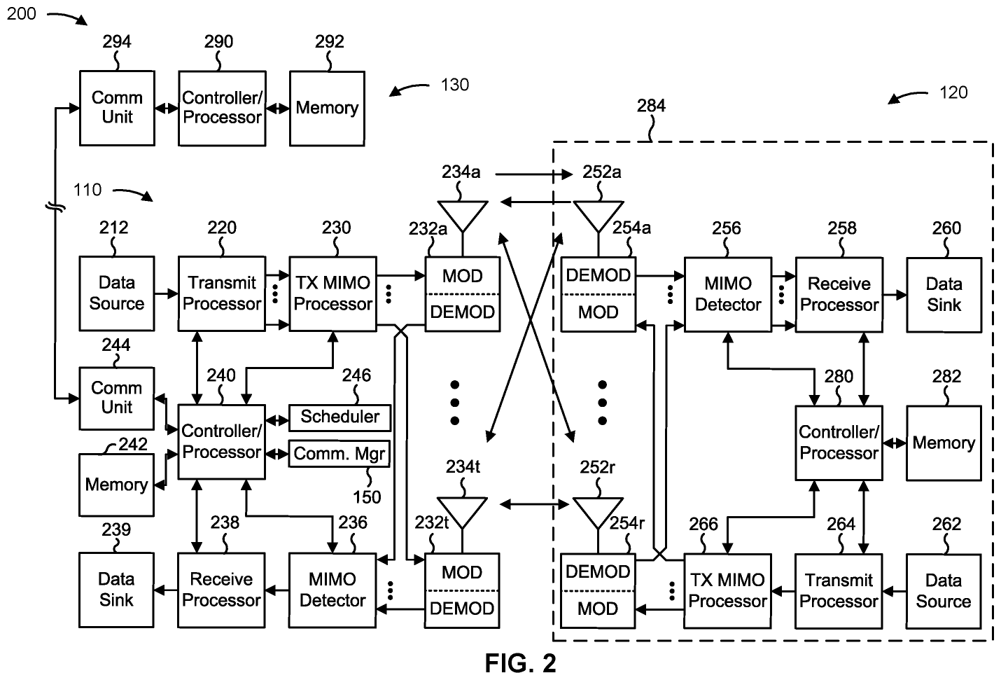

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

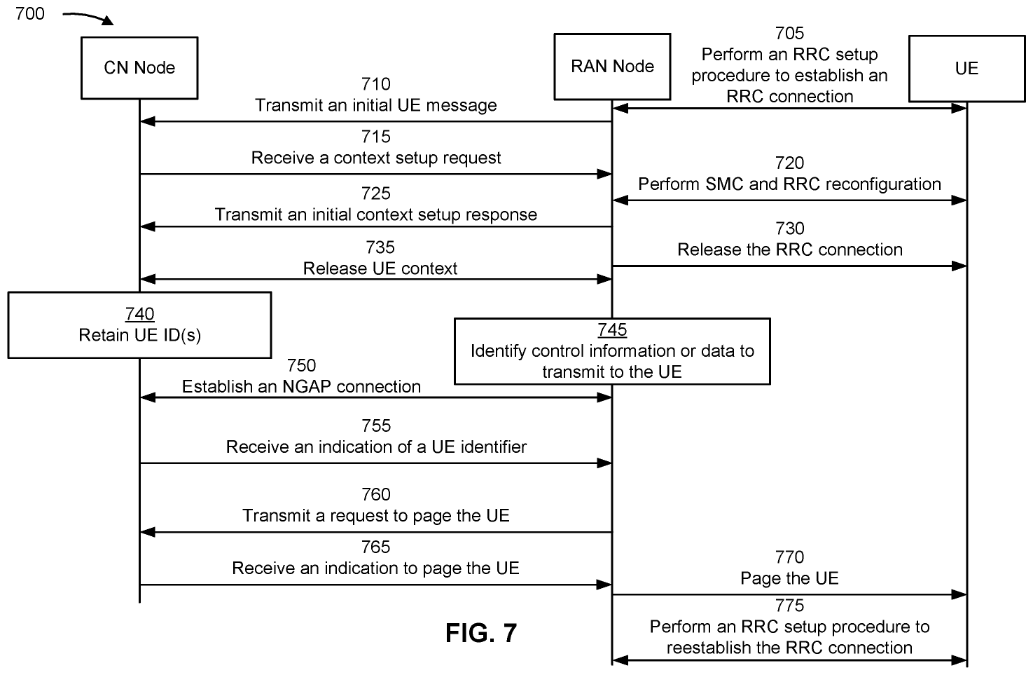

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

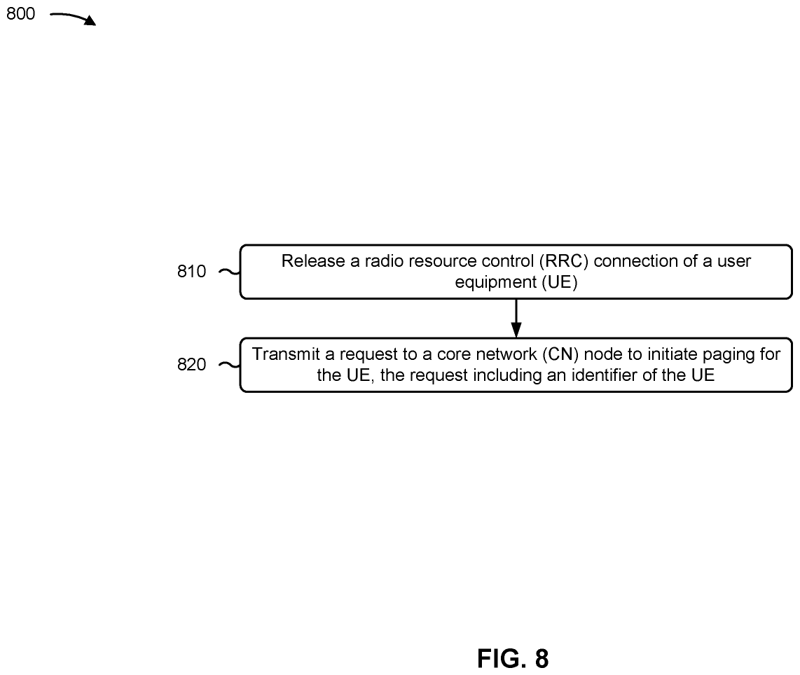

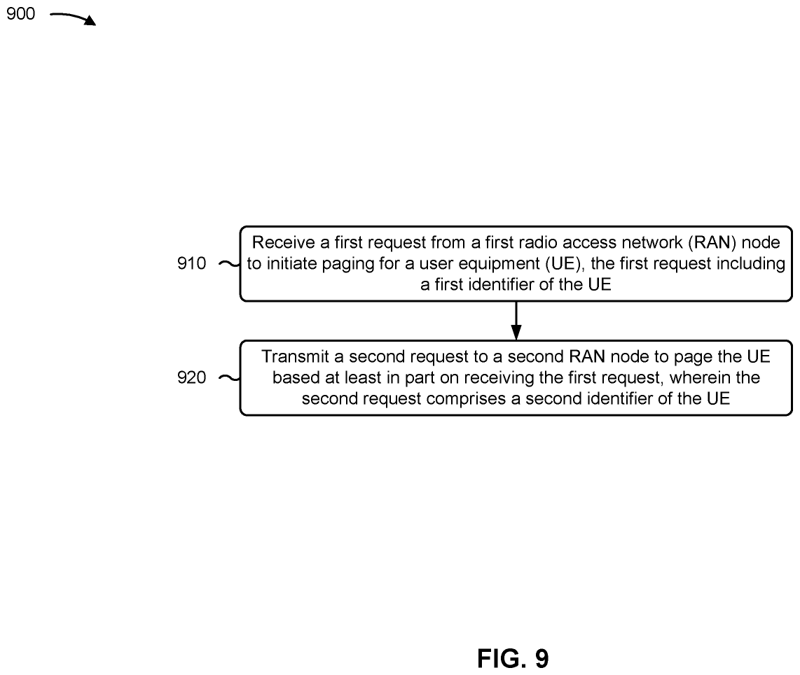

The controller/processor 240 of the network node 110, the controller/processor 280 of the UE 120, and/or any other component(s) of FIG. 2 may perform one or more techniques associated with a RAN node request for core network paging, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a RAN node includes means for releasing an RRC connection of a UE; and/or means for transmitting a request to a CN node to initiate paging for the UE, the request including an identifier of the UE. In some aspects, the means for the RAN node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a CN node (e.g., an access and mobility function (AMF)) includes means for receiving a first request from a first RAN node to initiate paging for a UE, the first request including a first identifier of the UE; and/or means for transmitting a second request to a second RAN node to page the UE based at least in part on receiving the first request, wherein the second request comprises a second identifier of the UE. In some aspects, the means for the CN node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open RAN (O-RAN (such as the network configuration sponsored by the O-RAN Alliance)), or a virtualized RAN (vRAN, also known as a cloud RAN (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

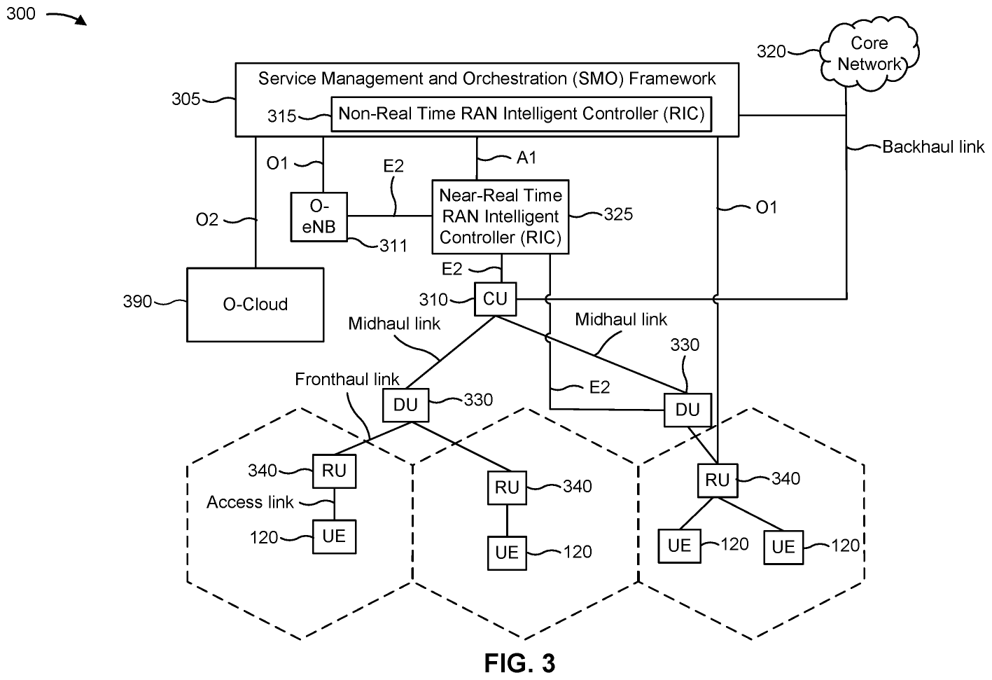

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

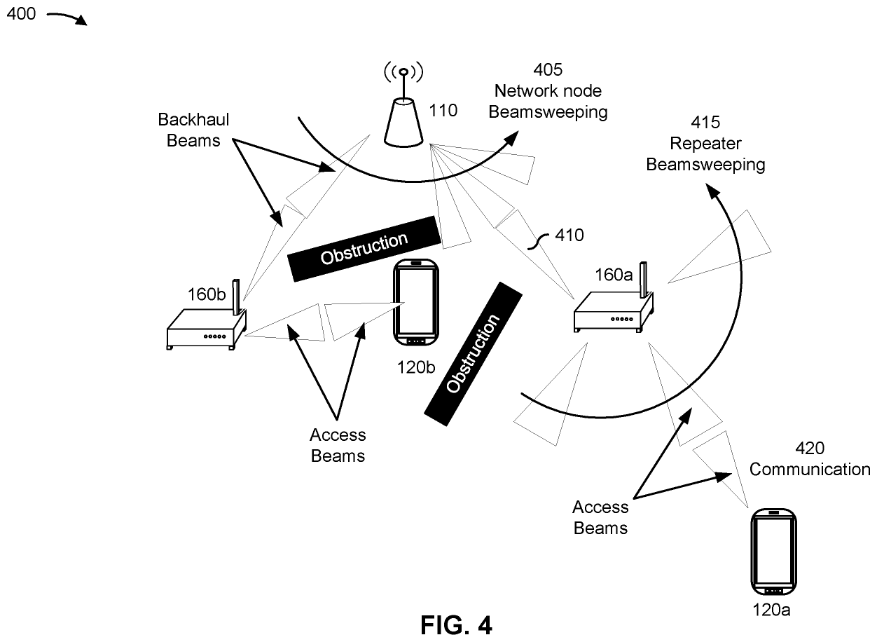

FIG. 4 is a diagram illustrating an example 400 of communicating using a millimeter wave repeater, in accordance with the present disclosure.

Because millimeter wave communications have a higher frequency and shorter wavelength than other types of radio waves used for communications (e.g., sub-6 GHz communications), millimeter wave communications may have shorter propagation distances and may be more easily blocked by obstructions than other types of radio waves. For example, a wireless communication that uses sub-6 GHz radio waves may be capable of penetrating a wall of a building or a structure to provide coverage to an area on an opposite side of the wall from a network node 110. However, a millimeter wave may not be capable of penetrating the same wall (e.g., depending on a thickness of the wall and/or a material from which the wall is constructed). Some techniques and apparatuses described herein use a millimeter wave repeater 160 (which includes, in the example of FIG. 4, repeater 160a and repeater 160b) to increase the coverage area of a network node 110 and/or to extend coverage to UEs 120 (which include, in the example of FIG. 4, UE 120a and UE 120b) without line of sight to the network node 110 (e.g., due to an obstruction).

For example, as illustrated in the example of FIG. 4, an obstruction between UE 120b and network node 110 blocks or otherwise reduces the quality of a link between the network node 110 and UE 120b. Similarly, an obstruction between UE 120b and repeater 160a blocks or otherwise reduces the quality of a link between the repeater 160a and the UE 120b. However, no obstructions or fewer obstructions exist between repeater 160b and UE 120b, and, as a result, it is possible that communications between repeater 160b and UE 120b will have a higher quality than communications between network node 110 and UE 120b or between repeater 160a and UE 120b. Furthermore, the millimeter wave repeater 160 described herein may be a layer 1 or an analog millimeter wave repeater, which is associated with lower cost, less processing, and lower latency than a layer 2 or layer 3 repeater.

A millimeter wave repeater 160 (sometimes referred to herein as a repeater 160) may perform directional communication by using beamforming to communicate with a network node 110 via a first beam pair (e.g., a backhaul beam pair over a backhaul link with the network node 110) and to communicate with a UE 120 via a second beam pair (e.g., an access beam pair over an access link with the UE 120). For example, in example 400, repeater 160a can communicate with network node 110 via a first beam pair and can communicate with UE 120a via a second beam pair. Similarly, repeater 160b can communicate with network node 110 via a first beam pair and can communicate with UE 120a via a second beam pair. “Beam pair” may refer to a transmit (Tx) beam used by a first device for transmission and a receive (Rx) beam used by a second device for reception of information transmitted by the first device via the Tx beam.

As shown by reference number 405, a network node 110 may use a beamsweeping procedure to transmit communications via multiple beams over time (e.g., using time division multiplexing (TDM)). As shown by reference number 410, the repeater 160a may receive a communication via an Rx beam of the repeater 160a. As shown by reference number 415, the repeater 160a may relay each received communication via multiple Tx beams of the repeater 160a (e.g., using TDM). As used herein, “relaying” a communication may refer to transmitting the received communication (e.g., after amplifying the received communication) without decoding the received communication and/or without modifying information carried in the received communication. Alternatively, relaying a received communication may refer to transmitting the received communication after decoding the received communication and/or modifying information carried in the received communication. In some aspects, a received communication may be relayed using a different time resource, a different frequency resource, and/or a different spatial resource (e.g., a different beam) to transmit the communication as compared to a time resource, a frequency resource, and/or a spatial resource in which the communication was received. As shown by reference number 420, a UE 120a may receive a relayed communication. In some aspects, the UE 120a may generate a communication to be transmitted to the network node 110. The UE 120a may then transmit the communication to the repeater 160a for relaying to the network node 110.

As indicated above, FIG. 4 is provided as an example. Other examples may differ from what is described with regard to FIG. 4.

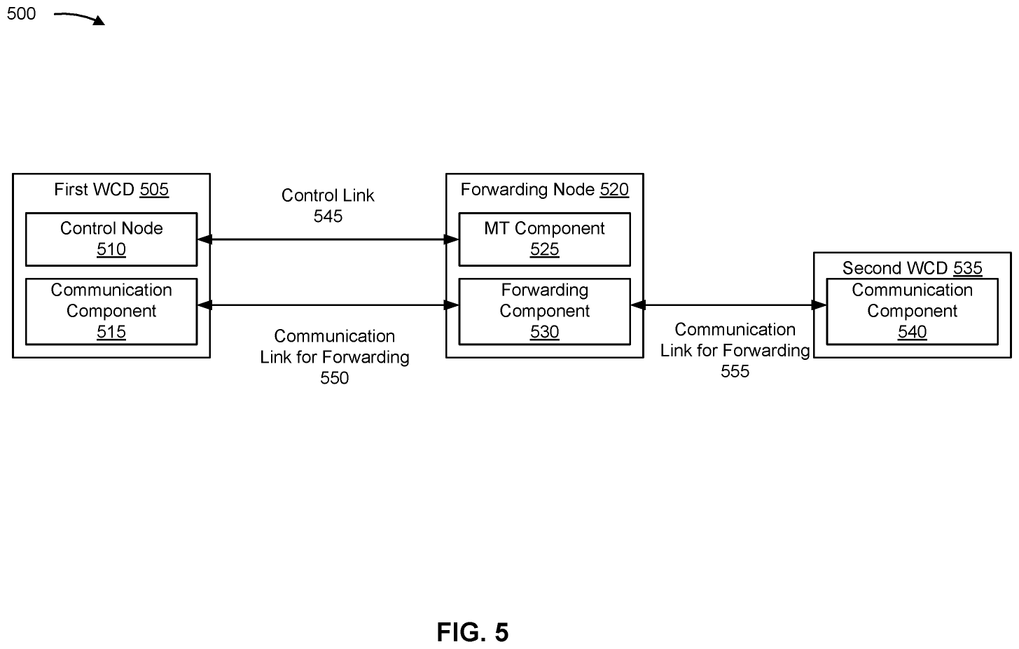

FIG. 5 is a diagram illustrating an example 500 of communicating using a forwarding node (e.g., a relay and/or a repeater, such as a millimeter wave repeater), in accordance with the present disclosure.

As shown in FIG. 5, a first WCD 505 (e.g., a network node 110 or a UE 120) may include a control node 510. The control node may be configured to exchange control information with connected forwarding nodes. For example, the control node 510 may be configured to provide control information to connected forwarding nodes to indicate one or more parameters for forwarding communications. The first WCD 505 may include a communication component 515 that is configured to communicate with one or more additional WCDs (e.g., via one or more connected forwarding nodes).

As further shown in FIG. 5, a forwarding node 520 may be connected to the first WCD 505. The forwarding node 520 may include a mobile terminal (MT) component 525 (also referred to as a UE) that is configured to communicate with the control node 510 of the first WCD 505. Communications associated with the MT component 525 terminate or initiate at the forwarding node 520, such as control information from and/or feedback to the first WCD 505. The forwarding node 520 may include a forwarding component 530 that is configured to receive and forward communications to and/or from the first WCD 505 (e.g., the communication component 515). The forwarding component 530 may be configured to operate based at least in part on control information received at the MT component 525.

In some examples, the forwarding node 520 may include a network controlled repeater (NCR) that is configured to operate based at least in part on control information from the first WCD 505 (e.g., a network node and/or a control node of an associated network). In some examples, the MT component 525 may include an NCR-MT and the forwarding component 530 may include an NCR-Fwd (NCR forwarding component).

The forwarding node 520 may provide a wireless connection between the first WCD 505 and a second WCD 535. The second WCD 535 may include a communication component 540 for receiving from and/or transmitting to the forwarding node 520 (e.g., the forwarding component).

The control node 510 and the MT component 525 may establish a control link 545 through which the first WCD 505 may provide control information to the forwarding node 520. The control information may be used to control and/or configure operations of the forwarding component 530.

The communication component 515 may establish a communication link 550 for forwarding with the forwarding component 530. The communication component 540 may establish a communication link 555 for forwarding with the forwarding component 530. The communication links for forwarding may be based at least in part on the control information provided by the control node 510.

In some examples, the first WCD 505 may include a network node and the communication link 550 may be a backhaul link. The backhaul link may be a direct link or may include multiple hops to the network node. In some examples, the second WCD 535 may include a UE and the communication link 555 may be an access link.

As indicated above, FIG. 5 is provided as an example. Other examples may differ from what is described with regard to FIG. 5.

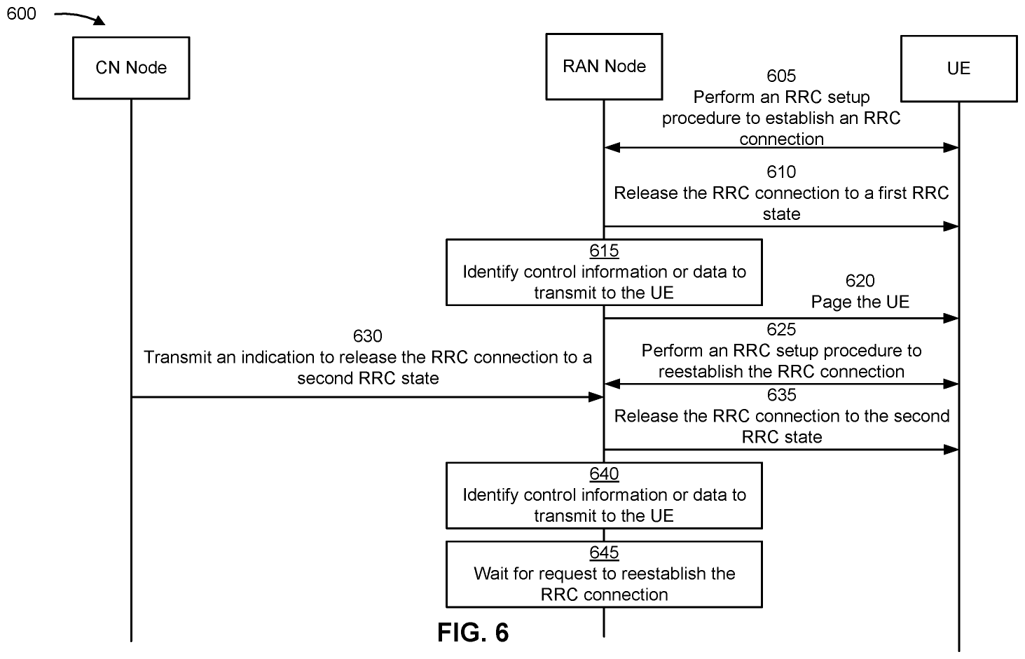

FIG. 6 is a diagram illustrating an example 600 of an RRC release and paging process. As shown in FIG. 6, a UE may communicate with a RAN node and the RAN node may be connected to a CN node (e.g., an AMF).

As shown by reference number 605, the UE and the RAN node may perform an RRC setup procedure to establish an RRC connection. For example, the RAN node and the UE may establish one or more radio bearers, a configuration of a search space for a control channel, periodic resources, and/or other configurations for communications.

Based at least in part on performing the RRC setup procedure, the UE may be in an RRC connected state. While in the RRC connected state, the UE may monitor a channel (e.g., a physical downlink control channel (PDCCH)) for scheduling information. Also while in the RRC connected state, the UE and the RAN node may communicate over the air.

As shown by reference number 610, the RAN node may release the RRC connection to a first RRC state. The RAN node may release the RRC connection based at least in part on inactivity of communications with the UE, failure to receive one or more responses from the UE, and/or a request from the UE or the CN node, among other examples. The first RRC state (e.g., an RRC-inactive state) may be a RAN-based RRC state where the RAN node has information needed to page the UE.

As shown by reference number 615, the RAN node may identify control information or data to transmit to the UE. Based at least in part on identifying control information or data to transmit to the UE, the RAN node may attempt to reestablish the RRC connection with the UE.

As shown by reference number 620, the RAN node may page the UE. The page may include a broadcast or multicast message that indicates one or more UEs to reestablish RRC connections with the RAN node. The message may include UE identifiers for each of the one or more UEs, with the UE identifiers known to the RAN node and respective UEs that are indicated by the UE identifiers.

As shown by reference number 625, the UE and the RAN node may perform an RRC setup procedure to reestablish the RRC connection. For example, the RAN node and the UE may establish one or more radio bearers, a configuration of a search space for a control channel, periodic resources, and/or other configurations for communications.

Based at least in part on establishing the RRC connection, the RAN node may transmit the control information and/or data to the UE. The UE and the RAN node may communicate until an RRC release occurs again.

As shown by reference number 630, the CN node may transmit, and the RAN node may receive, an indication to release the RRC connection to a second RRC state. The second RRC state may be a CN-based RRC state (e.g., RRC-idle state) where the CN node, and not the RAN node, has information needed to page the UE.

As shown by reference number 635, the RAN node may release the RRC connection to the second RRC state. Based at least in part on being in the second RRC state, the UE may not be reachable to the RAN node.

As shown by reference number 640, the RAN node may identify control information or data to transmit to the UE. The RAN node may identify data that originated from an application server that is intended for the UE or the RAN node may identify an update of control information associated with a different connection of the UE. For example, the UE may be an MT of a forwarding node that is performing forwarding and/or repeating operations at a forwarding component when the MT is in the second RRC state. The RAN node may attempt to update control information for the forwarding component when the MT is in the second RRC state, but the RAN node is unable to reach the UE.

As shown by reference number 645, the RAN node may wait for a request to reestablish the RRC connection. For example, the RAN node may wait for the UE to initiate a random access channel (RACH) procedure to reestablish the RRC connection. However, the UE may not initiate the RACH procedure within an efficient latency from the RAN node identifying control information or data to transmit to the UE. Additionally, or alternatively, the RAN node may wait until the CN node provides an indication to page the UE to trigger an RRC setup procedure to reestablish the RRC connection.

Based at least in part on the RAN node being unable to transmit the control information or data to the UE while the UE is in the second RRC state (e.g., an RRC-idle state), the control information may not be used to conserve power, network, communication, or computing resources, and/or an additional UE having a link to the RAN node via the UE may experience radio link failure and/or poor spectral efficiency. Additionally, or alternatively, the data may become stale and unusable, which may degrade performance and/or a user experience at the UE or the additional UE.

As indicated above, FIG. 6 is provided as an example. Other examples may differ from what is described with regard to FIG. 6.

In some aspects described herein, a RAN node may request a CN node to initiate paging for a UE in an idle state or other state where the RAN node does not have information or capability to page the UE without the CN node. For example, the RAN node may request the CN node to initiate paging for an MT of a forwarding node (such as an NCR-MT).

The RAN node may request to initiate paging for the MT of the forwarding node to allow the RAN node to provide side control information to the forwarding node. The side control information may indicate an update to a forwarding operation performed by the forwarding node when in the idle state.

In an example procedure, the RAN node may request the CN node to initiate paging for the UE in an idle state (also referred to as an idle RRC state or an RRC released state). The UE may be an NCR-MT. The CN node, upon receiving the request from the RAN node, may initiate paging of the UE. In some aspects, this may include requesting the RAN node to page the NCR-MT, or this may include requesting another RAN node to page the NCR-MT.

The request to page the NCR-MT may include a 5G System Architecture Evolution (SAE) temporary mobile subscriber identity (TMSI) (5G-S-TMSI or S-TMSI) allocated to the NCR-MT by the CN node.

In some aspects, the NCR-MT may include the 5G-S-TMSI in an RRC setup complete message when the NCR-MT first establishes an RRC connection with the RAN node. In some aspects, the RAN node may use the 5G-S-TMSI to attempt to initiate the paging. However, the 5G-S-TMSI may be reconfigured by the CN node and the 5G-S-TMSI indicated during the RRC setup may be outdated and inaccurate. In this case paging may fail unless receiving an update of the 5G-S-TMSI from the CN node for paging for the NCR-MT.

In another example, when the NCR-MT connects to the RAN node, the CN node (e.g., an AMF) and the RAN node may establish an NG connection associated with the NCR-MT. Upon establishing the NG connection, a pair of NG application protocol (AP) (NGAP) UE identifiers may be exchanged between the CN node and the RAN node. When the NCR-MT moves into RRC-idle state, the CN node may tear down the NG connection with the RAN node associated with the NCR-MT. In general, the NGAP UE identifiers may be released by the CN node based at least in part on the tear down of the NG connection.

However, the CN node may be configured or requested to retain the NGAP IDs for the NCR-MT. The CN node may maintain or release the NCR-MT-associated NG connection with the RAN node while retaining the NGAP IDs. The RAN node may indicate the NGAP IDs for the NCR-MT into the request to the AMF to initiate paging for the NCR-MT. In some aspects, the CN node may release the NGAP IDs based at least in part on receiving an indication (e.g., from the RAN node) to release the NGAP ID(s) for the NCR-MT (e.g., based at least in part on disconnecting from the NCR-MT, including the forwarding component of the NCR, for example).

Based at least in part on the RAN node being able to request paging of a UE in a CN-based RRC released state, the RAN node may provide control information that may be used to conserve power, network, communication, or computing resources, and/or an additional UE having a link to the RAN node via the UE may avoid radio link failure and/or communicate with improved spectral efficiency. Additionally, or alternatively, the data may be provided to the UE within a latency requirement and/or before expiry of the date, which may improve performance and/or a user experience at the UE or the additional UE.

FIG. 7 is a diagram of an example 700 associated with a RAN node request for CN paging, in accordance with the present disclosure. As shown in FIG. 7, a RAN node (e.g., network node 110, a CU, a DU, and/or an RU) may communicate with a UE (e.g., UE 120 and/or an entity of a repeater node, such as an MT component 525 and/or an NCR-MT). In some aspects, the network node and the UE may be part of a wireless network (e.g., wireless network 100). The RAN node may communicate with a CN node, such as an AMF, to support communications between the RAN node and the UE.

As shown by reference number 705, the UE and the RAN node may perform an RRC setup procedure to establish an RRC connection. For example, the RAN node and the UE may establish one or more radio bearers, a configuration of a search space for a control channel, periodic resources, and/or other configurations for communications. In some aspects, the UE may indicate a UE identifier, such as a TMSI (e.g., a 5G-S-TMSI), to the RAN node.

As shown by reference number 710, the RAN node may transmit, and the CN node may receive, an initial UE message. The initial UE message may include a RAN UE NGAP identifier. This may be referred to as an identifier of an NGAP associated with the UE.

As shown by reference number 715, the CN node may transmit, and the RAN node may receive, a context setup request. The context setup request may indicate the identifier of the NGAP associated with the UE and/or an AMF UE NGAP ID. The request may indicate that the RAN node is to configure or reconfigure a Security Mode Command (SMC) and RRC connection.

As shown by reference number 720, the RAN node and the UE may perform SMC and RRC reconfiguration.

As shown by reference number 725, the RAN node may transmit, and the CN node may receive, an initial context setup response.

As shown by reference number 730, the RAN node may release the RRC connection with the UE. For example, the RAN node may transmit, and the UE may receive, an indication of the RRC release. In some aspects, the RAN node may release the RRC connection based at least in part on inactivity of communications with the UE, failure to receive one or more responses from the UE, and/or a request from the UE or the CN node, among other examples. The release of the RRC connection may transition the UE to an RRC state that is associated with the CN node and not the RAN node (e.g., an RRC-idle state or an RRC-inactive) where the CN node has information to page the UE and the RAN node may not (e.g., information may be outdated).

As shown by reference number 735, the CN node and the RAN node may release UE context. For example, the CN node and the RAN node may tear down an NGAP connection associated with the UE.

As shown by reference number 740, the CN node may retain one or more UE identifiers associated with the UE. For example, the CN node may retain a first UE identifier known to the UE and the CN node. Additionally, or alternatively, the CN node may retain a second UE identifier that is known to the CN node and the RAN node so the RAN node can identify the UE using the second UE identifier. The CN node may map the first UE identifier to the second UE identifier such that, based at least in part on receiving the second UE identifier in a request to page the UE, the CN node may respond with an indication to page the UE using the first UE identifier.

In some aspects, the CN node may retain the one or more UE identifiers based at least in part on receiving an indication, from the RAN node, to retain an identifier for the UE after release of the RRC connection of the UE. For example, the RAN node may transmit the indication within the initial UE message, the initial context setup response, within the release UE context, and/or in a separate message, among other examples. In some aspects, the request includes an indication that the UE includes, or is included in, a repeater (e.g., the UE is an NCR-MT). In some aspects, the CN node may further maintain the NGAP connection with the CN node that was established prior to releasing the RRC connection with the UE (e.g., based at least in part on the indication to retain the one or more UE identifiers and/or the indication that the UE includes, or is included in, a repeater).

In some aspects, the CN node may retain the one or more UE identifiers based at least in part on receiving a first indication to retain an identifier of the UE (e.g., to retain the identifier after release of the RRC connection). In some aspects, the CN node may retain the one or more UE identifiers until reception of a second indication to release the identifier for the UE or until expiration of a maintenance period. In some aspects, the maintenance period may be configured by the RAN node, configured by another network node, or indicated within a communication protocol.

In some aspects, the one or more UE identifiers include an NGAP UE identifier, a pair of NGAP UE identifiers, an S-TMSI, and/or a TMSI, among other examples. In some aspects, the one or more UE identifiers may be derived from another UE identifier (e.g., using a hash).

As shown by reference number 745, the RAN node may identify control information or data to transmit to the UE. Based at least in part on identifying control information or data to transmit to the UE, the RAN node may attempt to reestablish the RRC connection with the UE. In some aspects, the control information may include side control information that updates one or more parameters of a forwarding function of the UE (e.g., an NCR-MT). The side control information may be needed to conserve power and computing resources of the UE, to reduce noise caused by an outdated amplify and forward configuration, and/or to update one or more transmission parameters associated with mobility of a connected additional UE, among other examples.

As shown by reference number 750, the RAN node may establish an NGAP connection with the CN node. For example, the RAN node may request to establish the NGAP connection based at least in part on identifying the control information or the data to transmit to the UE. In some aspects, the NGAP connection may support a request from the RAN node to page the UE. Alternatively, the RAN node may maintain the NGAP connection with the CN node that was established prior to releasing the RRC connection with the UE.

As shown by reference number 755, the RAN node may receive, and the CN node may transmit, an indication of a UE identifier associated with the UE. In some aspects, the UE identifier may be an up-to-date UE identifier that the RAN node can use to page the UE. In some aspects, the UE identifier may be valid for a time period.

As shown by reference number 760, the RAN node may transmit, and the CN node may receive, a request to page the UE. In some aspects, the request may include an identifier of the UE. The identifier may be known to the RAN node and the CN node, and may be unknown to the UE (e.g., an identifier that was never known to the UE or one that is expired or updated).

In some aspects, the RAN node may select the CN node for transmitting the request to page the UE based at least in part on receiving the context setup message for the UE prior to releasing the RRC connection for the UE. Additionally, or alternatively, transmitting the request to the network node may be based at least in part on receiving the context setup message from the RAN node.

In some aspects, the request to page the UE comprises a request for information for the CN node to use to page the UE. For example, the request to page the UE may include a request to page the UE upon receipt of the request to page, or the request to page the UE may include a request for information that the CN node may use to page the UE if needed.

In some aspects, the RAN node may select, and transmit the request to, the CN node based at least in part on previously transmitting a request to retain an identifier for the UE. In some aspects, the retained identifier is a same identifier of the UE included in the request.

As shown by reference number 765, the RAN node may receive, and the CN node may transmit, an indication to page the UE. In some aspects, the CN node may transmit the indication to page the UE based at least in part on receiving the request to page the UE described in connection with reference number 760. The indication to page the UE may include a UE identifier that is known to the UE. In this way, the UE may identify the page as directed to the UE, such that the UE may attempt to reestablish the RRC connection.

In some aspects, the UE identifier indicated within the indication to page the UE may be different from the UE identifier used in the request to page the UE. Alternatively, the UE identifiers may be the same.

As shown by reference number 770, the RAN node may page the UE. In some aspects, the RAN node may transmit a paging message that includes an indication of the UE identifier. In some aspects, the paging message may indicate one or more resources through which the UE may initiate a reconnection procedure.

In some aspects, the RAN node may transmit the paging message to the UE based at least in part on the indication to page the UE described in connection with reference number 765. For example, the paging message may include a UE identifier indicated within the indication to page the UE.

In some aspects, the RAN node may receive an indication of the UE identifier to allow the RAN mode to decide when or whether to page the UE. For example, the indication to page the UE may include a request to reestablish the RRC connection and/or may include information for the RAN node to use to reestablish the RRC connection based at least in part on a decision by the RAN node.

Alternatively, the RAN node may receive a UE identifier from the UE. For example, the RAN node may receive an RRC message (from the UE before the RRC release) that includes an identifier of the second UE and transmit a paging message to the UE including the identifier of the UE as received via the RRC message. The RRC message may be associated with the RRC setup, an SMC and RRC reconfiguration, or another RRC message.

As shown by reference number 775, the UE and the RAN node may perform an RRC setup procedure to reestablish the RRC connection.

Based at least in part on the RAN node being able to request paging of a UE in a CN-based RRC released state, the RAN node may provide control information that may be used to conserve power, network, communication, or computing resources, and/or an additional UE having a link to the RAN node via the UE may avoid radio link failure and/or communicate with improved spectral efficiency. Additionally, or alternatively, the data may be provided to the UE within a latency requirement and/or before expiry of the date, which may improve performance and/or a user experience at the UE or the additional UE.

As indicated above, FIG. 7 is provided as an example. Other examples may differ from what is described with respect to FIG. 7.

FIG. 8 is a diagram illustrating an example process 800 performed, for example, by a RAN node, in accordance with the present disclosure. Example process 800 is an example where the RAN node (e.g., network node 110, a CU, a DU, an RU, or a base station) performs operations associated with a RAN node request for core network paging.

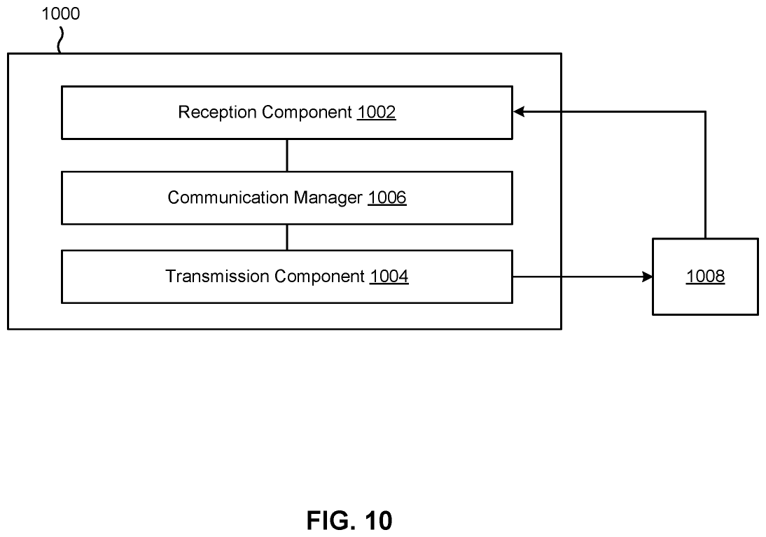

As shown in FIG. 8, in some aspects, process 800 may include releasing an RRC connection of a UE (block 810). For example, the RAN node (e.g., using communication manager 150 or communication manager 1006, depicted in FIG. 10) may release an RRC connection of a UE, as described above.

As further shown in FIG. 8, in some aspects, process 800 may include transmitting a request to a CN node to initiate paging for the UE, the request including an identifier of the UE (block 820). For example, the RAN node (e.g., using communication manager 150, transmission component 1004 and/or communication manager 1006, depicted in FIG. 10) may transmit a request to a CN node to initiate paging for the UE, the request including an identifier of the UE, as described above.

Process 800 may include additional aspects, such as any single aspect or any combination of aspects described below and/or in connection with one or more other processes described elsewhere herein.

In a first aspect, the UE comprises an entity of a repeater node.

In a second aspect, alone or in combination with the first aspect, releasing the RRC connection of the UE comprises a transition of the UE to an RRC-idle state or to an RRC-inactive state.

In a third aspect, alone or in combination with one or more of the first and second aspects, process 800 includes transmitting an RRC release message to the UE.

In a fourth aspect, alone or in combination with one or more of the first through third aspects, process 800 includes receiving, from the CN node, a context setup message for the UE prior to releasing the RRC connection, and selecting the CN node for transmitting the request based at least in part on the context setup message, wherein transmitting the request to the network node is based at least in part on receiving the context setup message.

In a fifth aspect, alone or in combination with one or more of the first through fourth aspects, process 800 includes transmitting an indication to the CN node to retain an identifier for the UE after release of the RRC connection of the UE, wherein the RAN node transmits the request to the CN node based on the transmission of the indication.

In a sixth aspect, alone or in combination with one or more of the first through fifth aspects, the indication is an indication that the UE comprises, or is comprised in, a repeater.

In a seventh aspect, alone or in combination with one or more of the first through sixth aspects, the RAN node retains an NG application protocol (AP) connection with the CN node associated with the UE based at least in part on transmitting the indication.

In an eighth aspect, alone or in combination with one or more of the first through seventh aspects, process 800 includes transmitting a first indication to the CN node to retain an identifier for an additional UE after release of the RRC connection of the additional UE, and transmitting a second indication to the CN node to release the identifier for the additional UE.

In a ninth aspect, alone or in combination with one or more of the first through eighth aspects, process 800 includes establishing an NG AP connection with the CN node associated with the UE after releasing the RRC connection of the UE, wherein transmitting the request to initiate the paging for the UE comprises transmitting the request via the NG AP connection.

In a tenth aspect, alone or in combination with one or more of the first through ninth aspects, the identifier of the UE comprises one or more of an NG AP UE identifier, a pair of NGAP UE identifiers, an S-TMSI, or a TMSI.

In an eleventh aspect, alone or in combination with one or more of the first through tenth aspects, process 800 includes receiving the identifier of the UE from the UE based at least in part on setting up the RRC connection prior to releasing the RRC connection.

In a twelfth aspect, alone or in combination with one or more of the first through eleventh aspects, process 800 includes receiving an RRC message, from a second UE, that includes an identifier of the second UE, releasing the RRC connection of the second UE, and transmitting a paging message to the second UE including the identifier of the second UE.

In a thirteenth aspect, alone or in combination with one or more of the first through twelfth aspects, process 800 includes receiving the UE identifier from the CN node.

In a fourteenth aspect, alone or in combination with one or more of the first through thirteenth aspects, process 800 includes receiving an additional request from the CN node to page the UE based at least in part on transmitting the request, wherein the additional request includes an additional identifier of the UE.

In a fifteenth aspect, alone or in combination with one or more of the first through fourteenth aspects, the additional request includes the identifier of the UE, or wherein the additional identifier of the UE is the same as the identifier of the UE.

In a sixteenth aspect, alone or in combination with one or more of the first through fifteenth aspects, process 800 includes receiving, from the CN node, a paging identifier of the UE from the CN node, and transmitting a paging message to the UE using the paging identifier, wherein the request to the CN node comprises a request for the paging identifier of the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a CN node, in accordance with the present disclosure. Example process 900 is an example where the CN node (e.g., network node 110 and/or an AMF) performs operations associated with radio RAN request for core network paging.

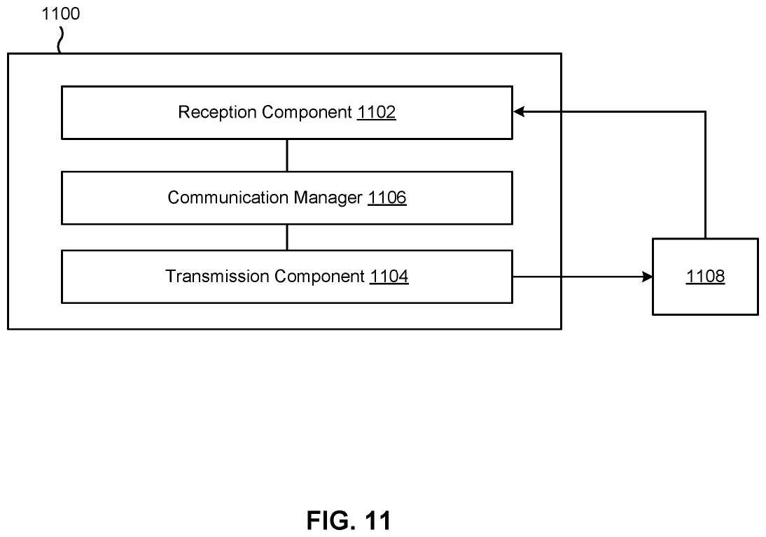

As shown in FIG. 9, in some aspects, process 900 may include receiving a first request from a first RAN node to initiate paging for a UE, the first request including a first identifier of the UE (block 910). For example, the CN node (e.g., using communication manager 150, reception component 1102 and/or communication manager 1106, depicted in FIG. 11) may receive a first request from a first RAN node to initiate paging for a UE, the first request including a first identifier of the UE, as described above.

As further shown in FIG. 9, in some aspects, process 900 may include transmitting a second request to a second RAN node to page the UE based at least in part on receiving the first request, wherein the second request comprises a second identifier of the UE (block 920). For example, the CN node (e.g., using communication manager 150, transmission component 1104 and/or communication manager 1106, depicted in FIG. 11) may transmit a second request to a second RAN node to page the UE based at least in part on receiving the first request, wherein the second request comprises a second identifier of the UE, as described above.

Process 900 may include additional aspects, such as any single aspect or any combination of aspects described below and/or in connection with one or more other processes described elsewhere herein.

In a first aspect, the UE comprises a repeater node.

In a second aspect, alone or in combination with the first aspect, one or more of: the first RAN node and the second RAN node are a same node, or the first identifier and the second identifier are a same identifier of the UE.

In a third aspect, alone or in combination with one or more of the first and second aspects, one or more of the first identifier or the second identifier comprise one or more of an NG AP UE identifier, a pair of NGAP UE identifiers, an S-TMSI, or a TMSI.

In a fourth aspect, alone or in combination with one or more of the first through third aspects, the UE is in an RRC-idle state or an RRC-inactive state prior to transmitting the second request to the second RAN node.

In a fifth aspect, alone or in combination with one or more of the first through fourth aspects, process 900 includes transmitting, to the first RAN node, a context setup message for the UE, and receiving the first request based at least in part on transmitting the context setup message.

In a sixth aspect, alone or in combination with one or more of the first through fifth aspects, process 900 includes receiving, from the first RAN node, an indication to retain an identifier for the UE after release of the RRC connection of the UE, wherein receiving the first request is based at least in part on receiving the indication.

In a seventh aspect, alone or in combination with one or more of the first through sixth aspects, the indication is an indication that the UE comprises, or is comprised in, a repeater.

In an eighth aspect, alone or in combination with one or more of the first through seventh aspects, process 900 includes retaining an NG AP connection with the first RAN node associated with the UE based at least in part on receiving the indication.

In a ninth aspect, alone or in combination with one or more of the first through eighth aspects, process 900 includes receiving, from the first RAN node, a first indication to retain an identifier for a second UE, and receiving a second indication from the first RAN node to release the identifier for the second UE.

In a tenth aspect, alone or in combination with one or more of the first through ninth aspects, process 900 includes establishing an NG AP connection with the first RAN node associated with the UE, wherein receiving the first request comprises receiving the request via the NGAP.

In an eleventh aspect, alone or in combination with one or more of the first through tenth aspects, process 900 includes transmitting the first identifier to the RAN node, wherein receiving the first request including the first identifier is based at least in part on transmitting the first identifier to the RAN node.

In a twelfth aspect, alone or in combination with one or more of the first through eleventh aspects, the first request comprises a request for a paging identifier for the UE, and transmitting the second request comprises providing the second identifier as a paging identifier for the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a RAN node, or a RAN node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the RAN node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the RAN node described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the RAN node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The communication manager 1006 may release an RRC connection of a UE. The transmission component 1004 may transmit a request to a CN node to initiate paging for the UE, the request including an identifier of the UE.

The transmission component 1004 may transmit an RRC release message to the UE.

The reception component 1002 may receive, from the CN node, a context setup message for the UE prior to releasing the RRC connection.

The communication manager 1006 may select the CN node for transmitting the request based at least in part on the context setup message, wherein transmitting the request to the network node is based at least in part on receiving the context setup message.

The transmission component 1004 may transmit an indication to the CN node to retain an identifier for the UE after release of the RRC connection of the UE, wherein the RAN node transmits the request to the CN node based on the transmission of the indication.

The transmission component 1004 may transmit a first indication to the CN node to retain an identifier for an additional UE after release of the RRC connection of the additional UE.

The transmission component 1004 may transmit a second indication to the CN node to release the identifier for the additional UE.

The communication manager 1006 may establish an NG AP connection with the CN node associated with the UE after releasing the RRC connection of the UE, wherein transmitting the request to initiate the paging for the UE comprises transmitting the request via the NG AP connection.

The reception component 1002 may receive the identifier of the UE from the UE based at least in part on setting up the RRC connection prior to releasing the RRC connection.

The reception component 1002 may receive an RRC message, from a second UE, that includes an identifier of the second UE.

The communication manager 1006 may release the RRC connection of the second UE.

The transmission component 1004 may transmit a paging message to the second UE including the identifier of the second UE.

The reception component 1002 may receive the UE identifier from the CN node.

The reception component 1002 may receive an additional request from the CN node to page the UE based at least in part on transmitting the request, wherein the additional request includes an additional identifier of the UE.

The reception component 1002 may receive, from the CN node, a paging identifier of the UE from the CN node.

The transmission component 1004 may transmit a paging message to the UE using the paging identifier, wherein the request to the CN node comprises a request for the paging identifier of the UE.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a CN node, or a CN node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the CN node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the CN node described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the CN node described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a first request from a first RAN node to initiate paging for a UE, the first request including a first identifier of the UE. The transmission component 1104 may transmit a second request to a second RAN node to page the UE based at least in part on receiving the first request, wherein the second request comprises a second identifier of the UE.

The transmission component 1104 may transmit, to the first RAN node, a context setup message for the UE.

The reception component 1102 may receive the first request based at least in part on transmitting the context setup message.

The reception component 1102 may receive, from the first RAN node, an indication to retain an identifier for the UE after release of the RRC connection of the UE, wherein receiving the first request is based at least in part on receiving the indication.

The communication manager 1106 may retain an NG AP connection with the first RAN node associated with the UE based at least in part on receiving the indication.

The reception component 1102 may receive, from the first RAN node, a first indication to retain an identifier for a second UE.

The reception component 1102 may receive a second indication from the first RAN node to release the identifier for the second UE.

The communication manager 1106 may establish an NG AP connection with the first RAN node associated with the UE, wherein receiving the first request comprises receiving the request via the NGAP.

The transmission component 1104 may transmit the first identifier to the RAN node, wherein receiving the first request including the first identifier is based at least in part on transmitting the first identifier to the RAN node.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a radio access network (RAN) node, comprising: releasing a radio resource control (RRC) connection of a user equipment (UE); and transmitting a request to a core network (CN) node to initiate paging for the UE, the request including an identifier of the UE.

Aspect 2: The method of Aspect 1, wherein the UE comprises an entity of a repeater node.

Aspect 3: The method of any of Aspects 1-2, wherein releasing the RRC connection of the UE comprises a transition of the UE to an RRC-idle state or to an RRC-inactive state.

Aspect 4: The method of any of Aspects 1-3, further comprising: transmitting an RRC release message to the UE.

Aspect 5: The method of any of Aspects 1-4, further comprising: receiving, from the CN node, a context setup message for the UE prior to releasing the RRC connection; and selecting the CN node for transmitting the request based at least in part on the context setup message, wherein transmitting the request to the network node is based at least in part on receiving the context setup message.

Aspect 6: The method of any of Aspects 1-5, further comprising: transmitting an indication to the CN node to retain an identifier for the UE after release of the RRC connection of the UE, wherein the RAN node transmits the request to the CN node based on the transmission of the indication.

Aspect 7: The method of Aspect 6, wherein the indication is an indication that the UE comprises, or is comprised in, a repeater.

Aspect 8: The method of Aspect 6, wherein the RAN node retains an NG application protocol (AP) connection with the CN node associated with the UE based at least in part on transmitting the indication.

Aspect 9: The method of any of Aspects 1-8, further comprising: transmitting a first indication to the CN node to retain an identifier for an additional UE after release of the RRC connection of the additional UE; and transmitting a second indication to the CN node to release the identifier for the additional UE.

Aspect 10: The method of any of Aspects 1-9, further comprising: establishing an NG application protocol (AP) connection with the CN node associated with the UE after releasing the RRC connection of the UE, wherein transmitting the request to initiate the paging for the UE comprises transmitting the request via the NG AP connection.

Aspect 11: The method of any of Aspects 1-10, wherein the identifier of the UE comprises one or more of: an NG application protocol (AP) UE identifier, a pair of NGAP UE identifiers, a system architecture evolution (SAE) temporary mobile subscriber identity (S-TMSI), or a TMSI.

Aspect 12: The method of any of Aspects 1-11, further comprising: receiving the identifier of the UE from the UE based at least in part on setting up the RRC connection prior to releasing the RRC connection.

Aspect 13: The method of any of Aspects 1-12, further comprising: receiving an RRC message, from a second UE, that includes an identifier of the second UE, releasing the RRC connection of the second UE, and transmitting a paging message to the second UE including the identifier of the second UE.

Aspect 14: The method of any of Aspects 1-13, further comprising: receiving the UE identifier from the CN node.

Aspect 15: The method of any of Aspects 1-14, further comprising: receiving an additional request from the CN node to page the UE based at least in part on transmitting the request, wherein the additional request includes an additional identifier of the UE.

Aspect 16: The method of Aspect 15, wherein the additional request includes the identifier of the UE, or wherein the additional identifier of the UE is the same as the identifier of the UE.

Aspect 17: The method of any of Aspects 1-16, further comprising: receiving, from the CN node, a paging identifier of the UE from the CN node; and transmitting a paging message to the UE using the paging identifier, wherein the request to the CN node comprises a request for the paging identifier of the UE.

Aspect 18: A method of wireless communication performed by a core network (CN) node, comprising: receiving a first request from a first radio access network (RAN) node to initiate paging for a user equipment (UE), the first request including a first identifier of the UE; and transmitting a second request to a second RAN node to page the UE based at least in part on receiving the first request, wherein the second request comprises a second identifier of the UE.

Aspect 19: The method of Aspect 18, wherein the UE comprises a repeater node.

Aspect 20: The method of any of Aspects 18-19, wherein one or more of: the first RAN node and the second RAN node are a same node, or the first identifier and the second identifier are a same identifier of the UE.

Aspect 21: The method of any of Aspects 18-20, wherein one or more of the first identifier or the second identifier comprise one or more of: an NG application protocol (AP) UE identifier, a pair of NGAP UE identifiers, a system architecture evolution (SAE) temporary mobile subscriber identity (S-TMSI), or a TMSI.

Aspect 22: The method of any of Aspects 18-21, wherein the UE is in an RRC-idle state or an RRC-inactive state prior to transmitting the second request to the second RAN node.

Aspect 23: The method of any of Aspects 18-22, further comprising: transmitting, to the first RAN node, a context setup message for the UE; and receiving the first request based at least in part on transmitting the context setup message.

Aspect 24: The method of any of Aspects 18-23, further comprising: receiving, from the first RAN node, an indication to retain an identifier for the UE after release of the RRC connection of the UE, wherein receiving the first request is based at least in part on receiving the indication.

Aspect 25: The method of Aspect 24, wherein the indication is an indication that the UE comprises, or is comprised in, a repeater.

Aspect 26: The method of Aspect 24, further comprising: retaining an NG application protocol (AP) connection with the first RAN node associated with the UE based at least in part on receiving the indication.

Aspect 27: The method of any of Aspects 18-26, further comprising: receiving, from the first RAN node, a first indication to retain an identifier for a second UE; and receiving a second indication from the first RAN node to release the identifier for the second UE.

Aspect 28: The method of any of Aspects 18-27, further comprising: establishing an NG application protocol (AP) connection with the first RAN node associated with the UE, wherein receiving the first request comprises receiving the request via the NGAP.

Aspect 29: The method of any of Aspects 18-28, further comprising: transmitting the first identifier to the RAN node, wherein receiving the first request including the first identifier is based at least in part on transmitting the first identifier to the RAN node.

Aspect 30: The method of any of Aspects 18-29, wherein the first request comprises a request for a paging identifier for the UE, and wherein transmitting the second request comprises providing the second identifier as a paging identifier for the UE.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus of a radio access network (RAN) node for wireless communication, comprising:
one or more memories; and
one or more processors, coupled to the one or more memories, configured to:
release a radio resource control (RRC) connection of a user equipment (UE); and
transmit a request to a core network (CN) node to initiate paging for the UE, the request including an identifier of the UE.

2. The apparatus of claim 1, wherein the UE comprises an entity of a repeater node.

3. The apparatus of claim 1, wherein the one or more processors, to release the RRC connection of the UE, are configured to transition the UE to an RRC-idle state or to an RRC-inactive state.

4. The apparatus of claim 1, wherein the one or more processors are further configured to:
transmit an RRC release message to the UE.

5. The apparatus of claim 1, wherein the one or more processors are further configured to:
receive, from the CN node, a context setup message for the UE prior to releasing the RRC connection; and
select the CN node for transmitting the request based at least in part on the context setup message,
wherein the request is transmitted to the RAN node based at least in part on a receipt of the context setup message.

6. The apparatus of claim 1, wherein the one or more processors are further configured to:
transmit an indication to the CN node to retain an identifier for the UE after release of the RRC connection of the UE,
wherein the RAN node transmits the request to the CN node based on the transmission of the indication.

7. The apparatus of claim 6, wherein:
the indication is an indication that the UE comprises, or is comprised in, a repeater; and
the RAN node retains a Next Generation application protocol (NGAP) connection with the CN node associated with the UE based at least in part on transmitting the indication.

8. The apparatus of claim 1, wherein the one or more processors are further configured to:
transmit a first indication to the CN node to retain an identifier for an additional UE after release of the RRC connection of the additional UE; and
transmit a second indication to the CN node to release the identifier for the additional UE.

9. The apparatus of claim 1, wherein the one or more processors are further configured to:
establish a Next Generation application protocol (NGAP) connection with the CN node associated with the UE after releasing the RRC connection of the UE,
wherein the request to initiate the paging for the UE is transmitted via the NGAP connection.

10. The apparatus of claim 1, wherein the identifier of the UE comprises one or more of:
a Next Generation application protocol (NGAP) UE identifier,
a pair of NGAP UE identifiers,
a system architecture evolution (SAE) temporary mobile subscriber identity (S-TMSI),
or a temporary mobile subscriber identity (TMSI).

11. The apparatus of claim 1, wherein the one or more processors are further configured to:
receive the identifier of the UE from the UE based at least in part on setting up the RRC connection prior to releasing the RRC connection.

12. The apparatus of claim 1, wherein the one or more processors are further configured to:
receive an RRC message, from a second UE, that includes an identifier of the second UE,
release the RRC connection of the second UE, and
transmit a paging message to the second UE including the identifier of the second UE.

13. The apparatus of claim 1, wherein the one or more processors are further configured to:
receive the UE identifier from the CN node.

14. The apparatus of claim 1, wherein the one or more processors are further configured to:
receive an additional request from the CN node to page the UE based at least in part on transmitting the request,
wherein the additional request includes an additional identifier of the UE.

15. The apparatus of claim 14, wherein the additional request includes the identifier of the UE, or
wherein the additional identifier of the UE is the same as the identifier of the UE.

16. The apparatus of claim 1, wherein the one or more processors are further configured to:
receive, from the CN node, a paging identifier of the UE from the CN node; and
transmit a paging message to the UE using the paging identifier,
wherein the request to the CN node comprises a request for the paging identifier of the UE.

17. An apparatus of a core network (CN) for wireless communication, comprising:
one or more memories; and
one or more processors, coupled to the one or more memories, configured to:
receive a first request from a first radio access network (RAN) node to initiate paging for a user equipment (UE), the first request including a first identifier of the UE; and
transmit a second request to a second RAN node to page the UE based at least in part on receiving the first request, wherein the second request comprises a second identifier of the UE.

18. The apparatus of claim 17, wherein the UE comprises a repeater node.

19. The apparatus of claim 17, wherein one or more of:
the first RAN node and the second RAN node are a same node, or
the first identifier and the second identifier are a same identifier of the UE.

20. The apparatus of claim 17, wherein one or more of the first identifier or the second identifier comprise one or more of:
a Next Generation application protocol (NGAP) UE identifier,
a pair of NGAP UE identifiers,
a system architecture evolution (SAE) temporary mobile subscriber identity (S-TMSI),
or a temporary mobile subscriber identity (TMSI).

21. The apparatus of claim 17, wherein the UE is in a radio resource control (RRC)-idle state or an RRC-inactive state prior to transmitting the second request to the second RAN node.

22. The apparatus of claim 17, wherein the one or more processors are further configured to:
transmit, to the first RAN node, a context setup message for the UE; and
receive the first request based at least in part on transmitting the context setup message.

23. The apparatus of claim 17, wherein the one or more processors are further configured to:
receive, from the first RAN node, an indication to retain an identifier for the UE after release of a radio resource control (RRC) connection of the UE,
wherein the first request is received based at least in part on a receipt of the indication.

24. The apparatus of claim 23, wherein the indication is an indication that the UE comprises, or is comprised in, a repeater, or the one or more processors are further configured to:
retain a Next Generation application protocol (NGAP) connection with the first RAN node associated with the UE based at least in part on receiving the indication.

25. The apparatus of claim 17, wherein the one or more processors are further configured to:
receive, from the first RAN node, a first indication to retain an identifier for a second UE; and
receive a second indication from the first RAN node to release the identifier for the second UE.

26. The apparatus of claim 17, wherein the one or more processors are further configured to:
establish a Next Generation application protocol (NGAP) connection with the first RAN node associated with the UE,
wherein the first request is received via the NGAP.

27. The apparatus of claim 17, wherein the one or more processors are further configured to:
transmit the first identifier to the RAN node,
wherein the first request including the first identifier is received based at least in part on a transmission of the first identifier to the RAN node.

28. The apparatus of claim 17, wherein the first request comprises a request for a paging identifier for the UE, and
wherein the second request is transmitted based at least in part on providing the second identifier as a paging identifier for the UE.

29. A method of wireless communication performed by a radio access network (RAN) node, comprising:
releasing a radio resource control (RRC) connection of a user equipment (UE); and
transmitting a request to a core network (CN) node to initiate paging for the UE, the request including an identifier of the UE.

30. A method of wireless communication performed by a core network (CN) node, comprising:
receiving a first request from a first radio access network (RAN) node to initiate paging for a user equipment (UE), the first request including a first identifier of the UE; and
transmitting a second request to a second RAN node to page the UE based at least in part on receiving the first request, wherein the second request comprises a second identifier of the UE.
